(19) United States
(12) Patent Application Publication
(10) Pub. No.: US 2020/0021162 A1
(43) Pub. Date: Jan. 16, 2020

(54) MOTOR AND PUMP DEVICE

(71) Applicant: NIDEC SANKYO CORPORATION, Nagano (JP)

(72) Inventors: Nobuki KOKUBO, Nagano (JP); Takashi YAMAMOTO, Nagano (JP); Hiroki KURATANI, Nagano (JP); Masaki HARADA, Nagano (JP)

(21) Appl. No.: 16/485,946

(22) PCT Filed: Feb. 7, 2018
(86) PCT No.: PCT/JP2018/004139

§ 371 Date: Aug. 14, 2019

(30) Foreign Application Priority Data
Feb. 14, 2017 (JP) 2017-024963

(51) Int. Cl. H02K 5/10; H02K 5/08; F04D 29/08; F04D 13/06; H02K 7/14

(52) U.S. Cl. CPC H02K 5/10; H02K 5/08; F04D 29/086; F05B 2240/14; H02K 7/14; F05B 2240/57; F04D 13/06

(57) ABSTRACT

A motor may include a rotor including a rotating shaft and a magnet a bearing member; a stator including a plurality of coils arranged on the rotor; and a resin sealing member. The resin sealing member may include a bottom portion that covers the bearing member and the plurality of coils from a first direction side along an axis of the rotating shaft. The bottom portion may include a cylindrical bearing support section which surrounds the bearing member from an outer peripheral side in a radial direction, a coil sealing section positioned on the first direction side of the coils, and a connection section that connects between the bearing support section and the coil sealing section. A thickness of the connection section in an axial direction may be smaller than a thickness of the bearing support section and the coil sealing section.

### CROSS REFERENCE TO RELATED APPLICATIONS

This is the U.S. national stage of application No. PCT/JP2018/004139, filed on Feb. 7, 2018. Priority under 35 U.S.C. § 119(a) and 35 U.S.C. § 365(b) is claimed from Japanese Application No. 2017-024963, filed Feb. 14, 2017; the disclosures of which are incorporated herein by reference.

### TECHNICAL FIELD

At least an embodiment of the present invention relates to a motor in which a bearing member that rotatably supports a rotating shaft of a rotor, and coils of a stator are covered by a resin sealing member from one side in an axis line direction of the rotating shaft. Furthermore, at least an embodiment of the present invention relates to a pump device that drives an impeller with such a motor.

### BACKGROUND

Pump devices which include an impeller and a motor for rotating the impeller are known. In motors used in such pump devices, the coils are covered by a resin sealing member to protect the coils from water and the like. Patent Literature 1 describes a motor which includes a resin sealing member. The motor of this document includes: a rotor including a rotating shaft and a magnet; a stator including a plurality of coils annularly arranged on an outer peripheral side of the rotor; a bearing member that rotatably supports the rotor, and a resin sealing member. The stator has a stator core which includes an annular portion and a plurality of salient pole portions that protrude inward in a radial direction from the annular portion. The plurality of coils are wound around each of the plurality of salient pole portions via an insulator.

The resin sealing member includes a bottom portion that covers the bearing member and the plurality of coils from a first direction side, the first direction being one of the axis line directions of the rotating shaft, and a second direction being the opposite direction to the first direction. The bottom portion includes a bearing support section that surrounds the bearing member from the outer peripheral side in the radial direction, a coil sealing portion positioned on the first direction side of the coils, and a connection section that connects between the bearing support section and the coil sealing section. In this document, a first direction end surface of the bottom portion is a flat surface, and the thickness of the bearing member support section and the thickness of the connection section in an axis line direction are the same. Compared to the thickness of the connection portion and the bearing member support portion, the thickness of the coil sealing section is smaller by the amount in which the coils wound around the salient pole portions protrude from the stator core in the first direction.

### CITATION LIST

[Patent Literature 1] Japanese Unexamined Patent Application Publication No. 2007-267568

A coil generates heat when electric current is applied to the coil to drive the motor. When this heat is transmitted from the coil sealing section of the resin sealing member to the bearing support section via the connection portion, the bearing support section may be deformed by the heat, causing the posture of the bearing member to change. The position of the rotor inside the motor changes if the posture of the bearing member changes, and therefore, the rotational accuracy of the rotor can no longer be maintained.

### SUMMARY

Therefore, at least an embodiment of the present invention provides a motor in which heat generated at a coil can be inhibited from being transmitted to a bearing support section of a resin sealing member retaining a bearing member. Furthermore, at least an embodiment of the present invention provides a pump device for rotating an impeller with such a motor.

In order to solve the above problems, a motor according to at least an embodiment of the present invention includes: a rotor including a rotating shaft and a magnet; a bearing member that rotatably supports the rotating shaft; a stator including a plurality of coils annularly arranged on an outer peripheral side of the rotor; and a resin sealing member covering the coils; wherein the resin sealing member includes a bottom portion that covers the bearing member and the plurality of coils from a first direction side, the first direction being one of the axis line directions of the rotating shaft, and a second direction being the opposite direction to the first direction, the bottom portion includes a cylindrical bearing support section which surrounds the bearing member from an outer peripheral side in a radial direction, a coil sealing section positioned on the first direction side of the coils, and a connection section that connects between the bearing support section and the coil sealing section, and a thickness of the connection section in the axis line direction is smaller than a thickness of the bearing support section and the coil sealing section.

According to at least an embodiment of the present invention, the bottom portion of the resin sealing member includes a connection section disposed between the cylindrical bearing support section, which surrounds the bearing member from an outer peripheral side, and the coil sealing section, which is positioned on the first direction side of the plurality of coils, with the thickness of the connection section in the axis line direction being smaller than that of these sections. Therefore, when heat generated by energizing a coil is conducted from the coil sealing section to the inner peripheral side, the conduction is inhibited at the connection section, making conduction to the bearing support section less likely. Therefore, it is possible to prevent or inhibit deformation of the bearing support section caused by the heat, and the resulting change in the posture of the bearing member. As a result, the rotational accuracy of the rotor can be maintained.

In at least an embodiment of the present invention, it is desirable that a first direction side end surface of the connection section is positioned further on the second direction side than a first direction side end surface of the bearing support section and a first direction side end surface of the coil sealing section. In this manner, an annular concave portion, which has the first direction side bottom surface of the connection section as the bottom portion, is formed on the first direction end surface of the bottom portion. As a result, the surface area of the first direction end surface of the bottom portion increases, and therefore, heat from the coils is easily released via the bottom portion.

In at least an embodiment of the present invention, it is desirable that the first direction side end surface of the bearing support section is positioned further on the first direction side than the first direction side end surface of the coil sealing section. In this manner, compared to a case where the first direction side end surface of the bearing support section and the first direction side end surface of the coil sealing section are positioned with the same height, the surface area of the first direction end surface of the bottom portion can be increased. Therefore, heat from the coils is more easily released via the bottom portion.

In at least an embodiment of the present invention, a motor can be provided wherein the stator includes an annular portion and a plurality of salient pole portions that protrude inward in a radial direction from the annular portion, the plurality of coils is wound around each of the plurality of salient pole portions via an insulator, the coils wound around the insulator protrude in the first direction toward the outer peripheral side in a radial direction, and the first direction end surface of the coil sealing section includes a tapered surface section provided along the shape of the coils which is inclined in the first direction toward the outer peripheral side. If such a tapered surface section is provided, the surface area of a section of the coil sealing section facing the coils in the axis line direction increases. Therefore, heat from the coils is easily released via the tapered surface section.

In at least an embodiment of the present invention, it is desirable that the bearing member includes a cylindrical portion in which the rotating shaft passes through, and a flange portion which spreads out on the outer peripheral side from a second direction end of the cylindrical portion, the cylindrical portion is retained by the bearing support section from the outer peripheral side, the flange portion makes contact with the bearing support section from the second side, and a convex portion is formed on either an outer peripheral surface of the cylindrical portion or an inner peripheral surface of the bearing support section, and a concave portion which is fitted to the convex portion is formed on the other surface. In this manner, by fitting the convex portion and the concave portion together, it is possible to prevent the bearing member retained by a bearing retaining section from rotating about the axis line.

In at least an embodiment of the present invention, it is desirable that a contour of the flange portion is a letter-D shape which includes an arc contour section, and a straight contour section which linearly connects both circumferential direction ends of the arc contour section, and the straight contour section is positioned on the opposite side of the convex portion with respect to a central hole of the cylindrical portion. In this manner, the position of the convex portion formed on the cylindrical portion can be easily grasped even when the bearing member is viewed from the flange portion side. Therefore, at the time the bearing member is retained by the resin sealing member, the bearing member (convex portion) can be easily fitted to the bearing support section (groove portion).

In at least an embodiment of the present invention, a motor can be provided wherein a marker protrusion for disposing the straight contour section of the flange portion of the bearing member retained by the bearing support section at a predetermined angular position about the axis line is provided on the second direction end surface of the bottom portion. In this manner, the bearing member (convex portion) can be fitted to the bearing support section (groove portion) by means of the resin sealing member retaining the bearing member based on the marker.

Next, a pump device of at least an embodiment of the present invention includes: the motor described above; and an impeller attached to the rotating shaft.

According to at least an embodiment of the present invention, it is possible to prevent or inhibit the heat generated by the coils in the motor causing deformation of the bearing support section supporting the rotating shaft in the resin sealing member. As a result, it is possible to prevent or inhibit changes in the posture of the bearing member retained by the bearing support section, and therefore, it is possible to prevent or inhibit the position of the rotor, which includes the rotating shaft to which the impeller is attached, from changing inside the motor. Therefore, the rotational accuracy of the impeller driven by the motor can be maintained.

According to at least an embodiment of the present invention, in the motor, heat generated at a coil can be inhibited from being transmitted to the bearing support section of the resin sealing member retaining the bearing member. As a result, because changes in the posture of the bearing member retained by the bearing support section can be prevented or inhibited, the rotational accuracy of the rotor can be maintained.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 A cross-sectional view of a pump device according to an embodiment of the present invention.

FIG. 2 A perspective view of a motor of the pump device when viewed from the side on which a rotating shaft protrudes.

FIG. 3 A perspective view of a motor of the pump device when viewed from the opposite side to the side on which the rotating shaft protrudes.

FIG. 4 An exploded perspective view of the motor.

FIG. 5 An exploded perspective view of a cover member and a removed motor.

FIG. 6A and FIG. 6B An exploded perspective view of a rotor and an explanatory diagram of a securing structure of an E-ring.

FIG. 7 A perspective view of a stator.

FIG. 8 A perspective view of the cover member.

### DETAILED DESCRIPTION

Hereinafter, a pump device and a motor of an embodiment of the present invention is described with reference to the drawings.

### (Pump Device)

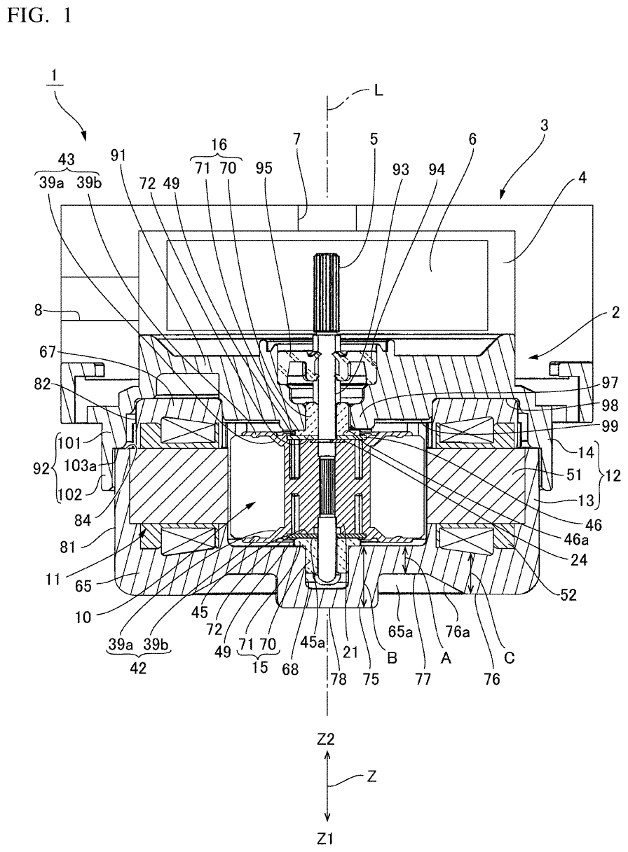

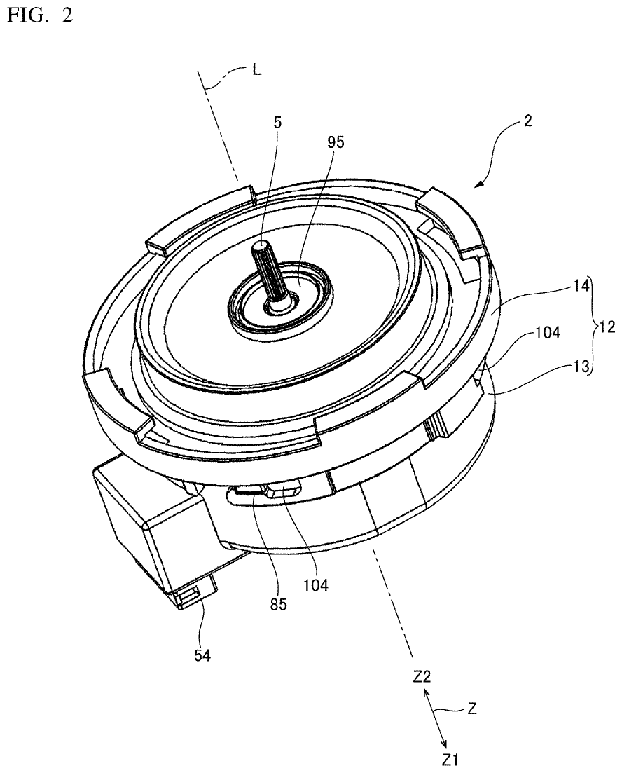

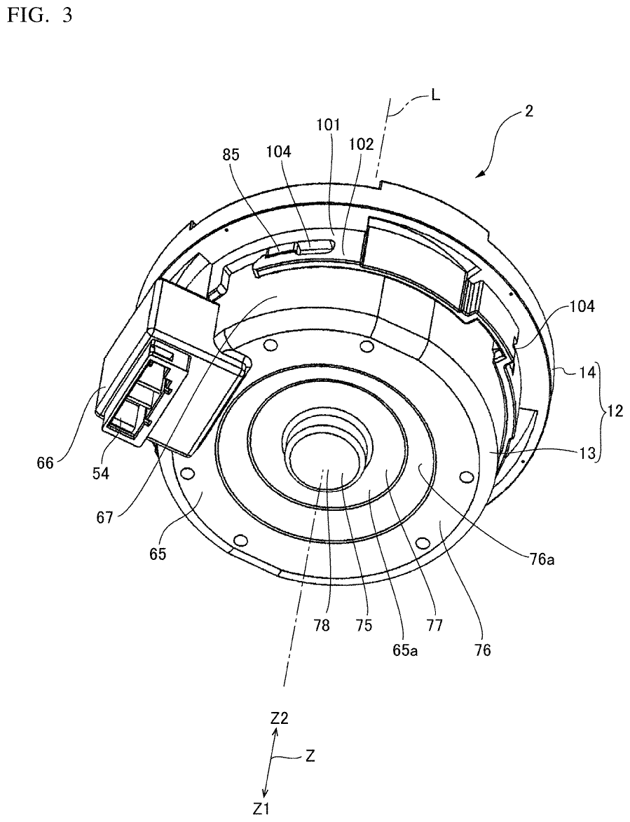

FIG. 1 is a cross-sectional view of a pump device according to an embodiment of the present invention. FIG. 2 is a perspective view of a motor serving as a drive source of the pump device when viewed from the output side on which a rotating shaft protrudes. FIG. 3 is a perspective view of the motor serving as a drive source of the pump device when viewed from the counter output side, which is the opposite side to the side on which the rotating shaft protrudes. As shown in FIG. 1, the pump device 1 includes: a motor 2; a case body 3 covering the motor 2; a pump chamber 4 partitioned between the motor 2 and the case body 3; and an impeller 6 attached to the rotating shaft 5 of the motor 2 and disposed inside the pump chamber 4. The case body 3 is provided with a fluid inlet port 7 and discharge port 8, and a fluid such as water drawn from the inlet port 7 is discharged from the discharge port 8 via the pump chamber 4 when the motor 2 is driven to rotate the impeller 6. In the following description, for convenience, an axis line L direction of the rotating shaft 5 is referred to as the vertical direction (Z direction). Furthermore, one side in the Z direction is referred to as the lower side or the downward direction (first direction Z1), and the other side is referred to as the upper side or upward direction (second direction Z2). The downward direction represents the direction from the pump chamber 4 toward the motor 2, and the lower side is the counter output side. The upward direction is the direction in which the rotating shaft 5 protrudes from the motor 2, and the upper side is the output side. Further, the direction orthogonal to the axis line L is referred to as the radial direction, and the axis line L periphery is referred to as the circumferential direction.

The motor 2 is a DC brushless motor, and includes a rotor 10, a stator 11, and a housing 12 that houses these components. As shown in FIG. 2 and FIG. 3, the housing 12 includes a resin sealing member 13 that covers the stator 11 from the lower side, and a cover member 14 that covers the resin sealing member 13 from the upper side. The resin sealing member 13 retains a first bearing member 15 which rotatably supports a lower side section of the rotating shaft 5. The cover member 14 retains a second bearing member 16 that rotatably supports the middle of the rotating shaft 5 of the rotor 10.

### (Rotor)

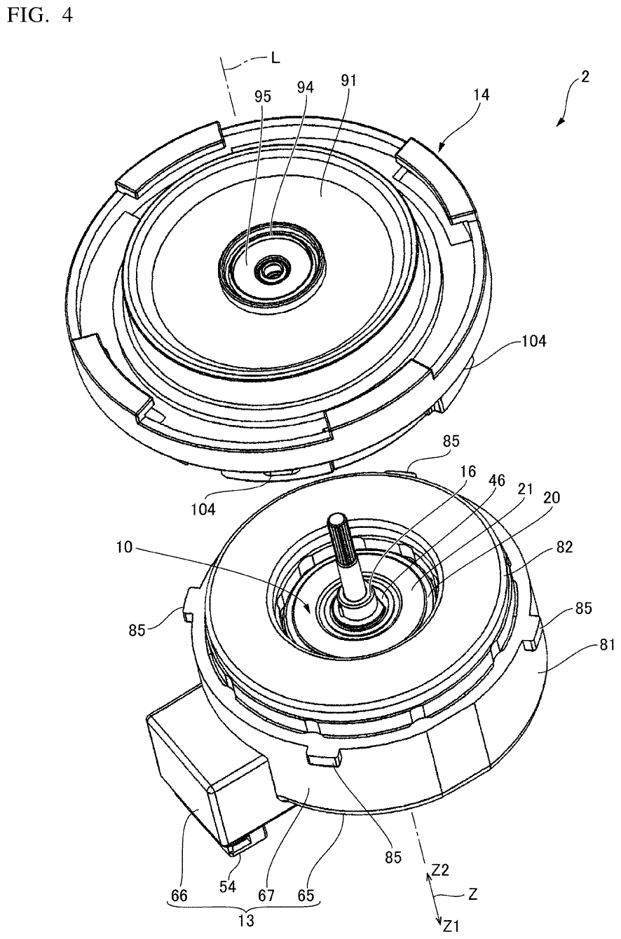

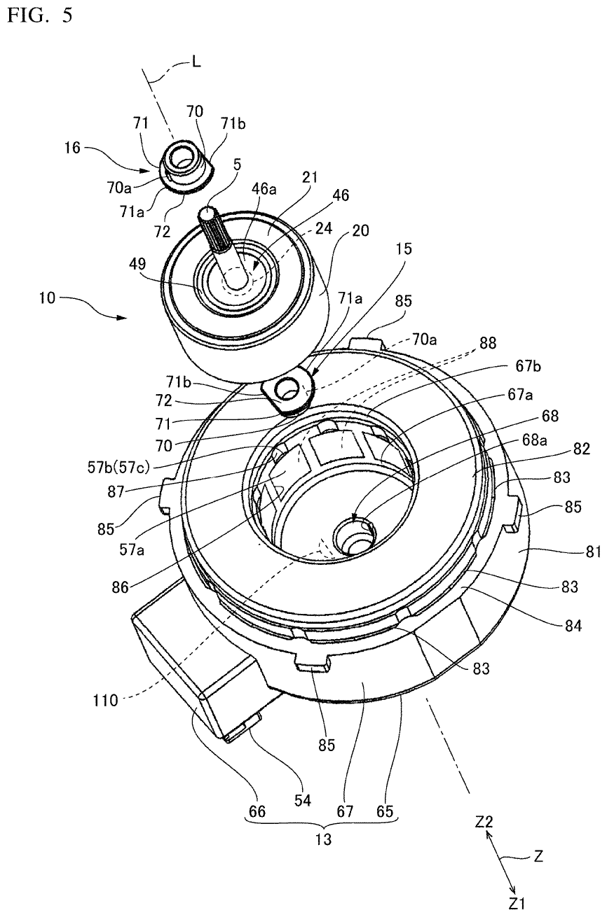

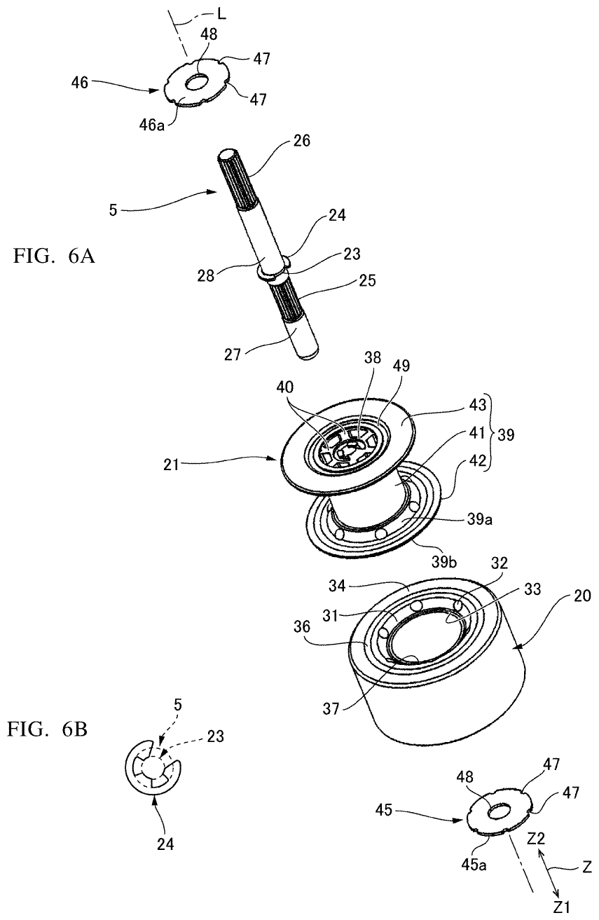

FIG. 4 is a perspective view of the motor 2 with the cover member 14 removed. FIG. 5 is an exploded perspective view of the motor 2 with the cover member 14 removed. FIG. 6A is an exploded perspective view of the rotor 10, and FIG. 6B is an explanatory diagram of a securing structure that secures an E-ring to the rotating shaft 5. As shown in FIG. 4 to FIG. 6A and FIG. 6B, the rotor 10 includes a rotating shaft 5, a magnet 20 surrounding the rotating shaft 5, and a retaining member 21 that retains the rotating shaft 5 and the magnet 20.

The rotating shaft 5 is made of stainless steel. As shown in FIG. 6A, the rotating shaft 5 is provided with an annular groove 23 slightly on the lower side of the center in the vertical direction. An E-ring 24 (metallic member) is attached to the annular groove 23. The E-ring 24 is a plate-shaped member made of metal. As shown in FIG. 6B, the E-ring 24 is secured to the annular groove 23 of the rotating shaft 5, and protrudes from the rotating shaft 5 to the outer peripheral side. Furthermore, the rotating shaft 5 is provided with a first knurled portion 25 of a predetermined length on the lower side of the annular groove 23. In addition, the rotating shaft 5 is provided with a second knurled portion 26 of a predetermined length from an upper end section toward the downward direction. The second knurled portion 26 is a section that upwardly protrudes from the housing 12 of the motor 2 and reaches the inside of the pump chamber 4, and is an attachment portion to which the impeller 6 is attached. A first supported portion 27 supported by the first bearing member 15 is provided on the lower side of the first knurled portion 25 of the rotating shaft 5. A second supported portion 28 supported by the second bearing member 16 is provided between the annular groove 23 and the second knurled portion 26 of the rotating shaft.

The magnet 20 has an annular shape and is disposed coaxially with the rotating shaft 5. The magnet 20 is disposed on the outer peripheral side of the first knurled portion 25. An outer peripheral surface of the magnet 20 has N poles and S poles alternatingly magnetized in the circumferential direction.

As shown in FIG. 6A and FIG. 6B, a tapered surface 31 which is downwardly inclined toward the inner peripheral side, and an annular surface 33 that extends toward the inner peripheral side from a lower end of the tapered surface 31 are continuously provided on an inner peripheral side end section of the upper surface of the magnet 20. Further, similarly to the upper surface, a tapered surface 31 which is upwardly inclined toward the inner peripheral side, and an annular surface 33 that extends toward the inner peripheral side from an upper end edge of the tapered surface 31 are continuously provided on an inner peripheral side end section of the lower surface of the magnet 20. The upper and lower tapered surfaces 31 have a plurality of concave portions 32 formed at equal angular intervals in the circumferential direction. The inner peripheral surface of the plurality of concave portions 32 has a spherical shape.

The upper surface of the magnet 20 beyond the tapered surface 31 on the outer peripheral side is an annular surface 34 orthogonal to the axis line L. The annular surface 34 is provided with an annular groove 36 that has a constant width and extends in the circumferential direction. A cross-section of the annular groove 36 when cut in the radial direction is a circular arc. The annular groove 36 is provided slightly on the inner peripheral side of the center of the annular surface 34. Similarly to the upper surface of the magnet 20, an annular groove 36 that has a constant width and extends in the circumferential direction is also provided in an annular surface 34 positioned on the outer peripheral side of the tapered surface 31 on the lower surface of the magnet 20. A cross-section of the annular groove 36 provided in the lower surface when cut in the radial direction is a circular arc. The annular groove 36 provided in the lower surface is provided slightly on the inner peripheral side of the center of the annular surface 34.

The retaining member 21 is a resin molded article, and retains a section that includes the first knurled portion 25 of the rotating shaft 5 from the outer peripheral side. The retaining member 21 includes a cylindrical rotating shaft retaining portion 38, a cylindrical magnet retaining portion 39 which retains the magnet 20 on the outer peripheral side of the rotating shaft retaining portion 38, and a plurality of connection portions 40 that radially extend from the rotating shaft retaining portion 38 in the radial direction to connect between the rotating shaft retaining portion 38 and the magnet retaining portion 39.

The magnet retaining portion 39 includes a magnet retaining cylindrical section 41 that covers an inner peripheral surface 37 of the magnet 20 from the inner peripheral side, and an annular first magnet retaining flange section 42 which spreads out from a lower end section of the magnet retaining cylindrical section 41 toward the outside, and an annular second magnet retaining flange section 43 which spreads out from an upper end section of the magnet retaining cylindrical section 41 toward the outside. The first magnet retaining flange section 42 covers a lower surface section of the magnet 20, which excludes an outer peripheral edge section of the lower surface. In other words, the first magnet retaining flange section 42 covers the lower surface of the magnet 20 up to the outer peripheral side of the annular groove 36. The second magnet retaining flange section 43 covers an upper surface section of the magnet 20, which excludes an outer peripheral edge section of the upper surface. In other words, the second magnet retaining flange section 43 covers the upper surface of the magnet 20 up to the outer peripheral side of the annular groove 36. The first magnet retaining flange section 42 and the second magnet retaining flange section 43 include a tapered surface cover portion 39a which covers the tapered surface 31, and an annular plate portion 39b positioned on the outer peripheral side of the tapered surface cover portion 39a and overlapping the annular surface 34. The tapered surface cover portion 39a is thicker in the vertical direction than the annular plate portion 39b. Here, the first magnet retaining flange section 42 and the second magnet retaining flange section 43 are shaped along the upper surface and the lower surface of the magnet 20, and make close contact with the inner peripheral surfaces of the concave portions 32 and the inner peripheral surface of the annular groove 36.

The number of connection portions 40 is the same as the number of concave portions 32 in the magnet 20. The retaining member 21 retains the magnet 20 such that the concave portions 32 of the magnet 20 are positioned on the outside of the connection portions 40 in the radial direction. The lower surfaces of the connection portions 40 are orthogonal to the axis line L. Furthermore, as shown in FIG. 1, the E-ring 24 secured to the rotating shaft 5 is retained in a state where a section that protrudes on the outer peripheral side from the rotating shaft 5 is embedded in the upper surface of the rotating shaft retaining portion 38. In the E-ring 24, the upper surface of the section that protrudes on the outer peripheral side from the rotating shaft 5 is upwardly exposed from the rotating shaft retaining portion 38. The upper surface of the E-ring 24, the upper surface of the rotating shaft retaining portion 38, and the upper surfaces of the connection portions 40 are positioned on the same plane orthogonal to the axis line L.

Next, the rotor 10 includes a first bearing plate 45 retained on the lower end side of the retaining member 21, and a second bearing plate 46 (second metallic member) retained on the upper end side of the retaining member 21. The first bearing plate 45 and the second bearing plate 46 are annular metal plates. The first bearing plate 45 and the second bearing plate 46 have a plurality of notched portions 47 at the outer peripheral edges. As a result, the first bearing plate 45 and the second bearing plate 46 are provided with unevenness at the outer peripheral edges.

The notched portions 47 are formed in six locations at equal angular intervals. The notched portions 47 formed in the first bearing plate 45 and the second bearing plate 46 face the connection portions 40 in the vertical direction. The first bearing plate 45 is secured to the retaining member 21 in a state where the rotating shaft 5 is passing through a central hole 48 of the first bearing plate 45, and covers the connection portions 40 and the rotating shaft retaining portion 38 from the lower end side of the retaining member 21. As shown in FIG. 1, when the first bearing plate 45 is secured to the retaining member 21, the lower surface of the first bearing plate 45 is orthogonal to the axis line L. The second bearing plate 46 is secured to the retaining member 21 in a state where the rotating shaft 5 is passing through a central hole 48 of the second bearing plate 46, and covers the connection portions 40, the rotating shaft retaining portion 38, and the E-ring 24 from the upper side of the retaining member 21. When the second bearing plate 46 is secured to the retaining member 21, the second bearing plate 46 and the E-ring 24 are in surface contact. The upper surface of the second bearing plate 46 is orthogonal to the axis line L. The upper surface of the second bearing plate 46 is a rotor side sliding surface 46a in sliding contact with the second bearing member 16 from the downward direction.

Here, formation of the retaining member 21 is performed by insert molding, in which the rotating shaft 5 to which the E-ring 24 is attached and the magnet 20 are placed inside a mold, and a resin is injected into the mold. The first bearing plate 45 and the second bearing plate 46 are retained by the retaining member 21 after insert molding.

When the first bearing plate 45 is retained by the retaining member 21, the rotating shaft 5 is passed through the central hole 48 of the first bearing plate 45, and the first bearing plate 45 is placed overlapping the connection portions 40 on the lower end side of the retaining member 21 and the rotating shaft retaining portion 38 on the lower end side. Thereafter, a section of the retaining member 21 positioned on the outer peripheral side of the first bearing plate 45 is plastically deformed by heat to cover an outer peripheral side section of the lower surface of the first bearing plate 45, and to cause the resin to enter into each of the notched portions 47. As a result, an annular plastically deformed portion 49 that covers the outer peripheral edge of the first bearing plate 45 from the downward direction and from the outer peripheral side is formed on the lower surface of the retaining member 21. The first bearing plate 45 is retained by the connection portions 40 (contact portions) on the lower end side of the retaining member 21, the rotating shaft retaining portion 38 (contact portion) on the lower end side, and the plastically deformed portion 49. Similarly, when the second bearing plate 46 is retained by the retaining member 21, the rotating shaft 5 is passed through the central hole 48 of the second bearing plate 46, the second bearing plate 46 is placed overlapping the connection portions 40 on the upper end side of the retaining member 21 and the rotating shaft retaining portion 38 on the upper end side, and the lower surface of the second bearing plate 46 is brought into surface contact with the upper surface of the E-ring 24. Thereafter, a section of the retaining member 21 positioned on the outer peripheral side of the second bearing plate 46 is plastically deformed by heat to cover an outer peripheral side section of the upper surface of the second bearing plate 46, and to cause the resin to enter into each of the notched portions 47. As a result, an annular plastically deformed portion 49 that covers the outer peripheral edge of the second bearing plate 46 from the upward direction and from the outer peripheral side is formed on the upper surface of the retaining member 21. The second bearing plate 46 is retained by the connection portions 40 (contact portions) on the upper end side of the retaining member 21, the rotating shaft retaining portion 38 (contact portion) on the upper end side, the upper surface of the E-ring 24, and the plastically deformed portion 49.

### (Stator)

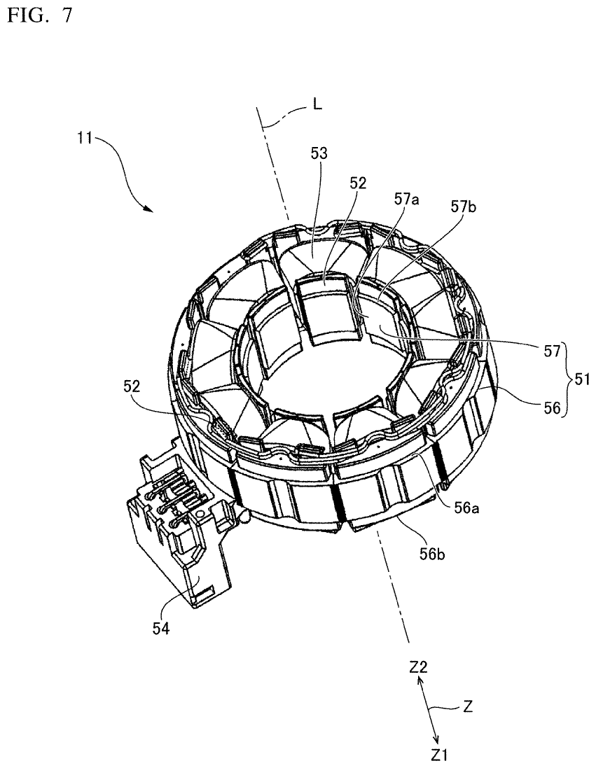

FIG. 7 is a perspective view of the stator 11. The stator 11 includes an annular stator core 51 positioned on the outer peripheral side of the rotor 10, a plurality of coils 53 wound around the stator core 51 via the insulators 52, and a connector 54 for connecting an electric feed line that supplies power to the coils 53.

The stator core 51 is a laminated core formed by laminating thin magnetic plates made of a magnetic material. As shown in FIG. 7, the stator core 51 includes an annular portion 56 and a plurality of salient pole portions 57 that inwardly protrude in the radial direction from the annular portion 56. The plurality of salient pole portions 57 are formed with an equal angular pitch, and are disposed at a constant pitch in the circumferential direction. In the present example, the plurality of salient pole portions 57 are formed with an angular pitch of 40° around on the axis line L. As a result, the stator core 51 is provided with nine salient pole portions 57. The inner peripheral side end surfaces 57a of the salient pole portions 57 are circular arc surfaces around the axis line L that face the outer peripheral surface of the magnet 20 of the rotor 10 with a slight gap.

The insulators 52 are formed from an insulating material such as a resin. The insulators 52 are formed with a flanged cylindrical shape having flange portions at both ends in the radial direction, and the salient pole portions 57 are attached such that the axial direction of the insulators 52, which formed in a cylindrical shape, coincide with the radial direction of the stator 11. Each of the coils 53 is wound around each of the plurality of salient pole portions 57 via the insulators 52. The coils 53 wound around the insulators 52 protrude in the vertical direction toward the outside in the radial direction. The insulators 52 partially cover the upper surface of the annular portion 56 of the stator core 51, but an outer peripheral edge section 56a of the upper surface of the annular portion 56 is not covered by the insulators 52. Similarly, the insulators 52 partially cover the lower surface of the annular portion 56 of the stator core 51, but an outer peripheral edge section 56b of the lower surface of the annular portion 56 is not covered by the insulators 52.

The tip section of each salient pole portion 57 protrudes from the insulator 52 toward the inner peripheral side. The section of each salient pole portion 57 exposed on the inner peripheral side from the insulator 52 (the section between the inner peripheral side end surface 57a and the section around which the coil 53 is wound) is provided with an axial direction end surface 57b orthogonal to the axis line L. One of the insulators 52 among the plurality of insulators 52 is integrally formed with the connector 54 such that a wire for supplying power to the coils 53 can be detachably connected.

### (Resin Sealing Member)

As shown in FIG. 5, the resin sealing member 13 includes a substantially disk-shaped sealing member bottom portion 65, which covers the coils 53, the insulators 52, and the stator core 51 from the downward direction. Furthermore, the resin sealing member 13 includes a sealing member overhang portion 66, which extends from the sealing member bottom portion 65 toward the outer peripheral side and covers the connector 54, and a sealing member cylindrical portion 67, which upwardly extends from the sealing member bottom portion 65 and covers the coils 53, the insulators 52, and the stator core 51.

A bearing member retaining concave portion 68 is provided in a central section of the upper surface of the sealing member bottom portion 65. The bearing member retaining concave portion 68 retains the first bearing member 15, which rotatably supports the rotor 10 on the lower side of the magnet 20 of the rotating shaft 5. The bearing member retaining concave portion 68 is a circular concave portion, and includes a groove 68a, which is provided in a circumferential direction section of the inner peripheral surface of the concave portion and extends in the vertical direction.

The first bearing member 15 is made of resin, and includes a cylindrical support portion 70 provided with a through hole in which the rotating shaft 5 passes through, and a flange portion 71 that spreads out on the outer peripheral side from the upward direction edge of the support portion 70. A convex portion 70a that has a constant width and extends in the vertical direction is formed on a circumferential direction section of the outer peripheral surface of the support portion 70. The contour of the flange portion 71 is a letter-D shape which includes an arc contour section 71a having an arc shape when viewed from the vertical direction, and a straight contour section 71b which linearly connects both circumferential ends of the arc contour section 71a. The straight contour section 71b is positioned on the opposite side of the convex portion 70a with respect to the through hole.

In the first bearing member 15, the support portion 70 is inserted into the bearing member retaining concave portion 68 in a state where the positions of the convex portion 70a of the support portion 70 and the groove 68a of the bearing member retaining concave portion 68 coincide with each other. Further, as shown in FIG. 1, the first bearing member 15 is secured to the bearing member retaining concave portion 68 by inserting the flange portion 71 from the upward direction until it makes contact with the sealing member bottom portion 65. When the first bearing member 15 is secured to the bearing member retaining concave portion 68, the upward direction end surface of the flange portion 71 is orthogonal to the axis line. Here, the support portion 70 functions as a radial bearing of the rotating shaft 5, and the flange portion 71 functions as a thrust bearing of the rotor 10. That is to say, the upward direction end surface of the flange portion 71 is a sliding surface 72 in sliding contact with the rotor 10. That is to say, the lower surface of the first bearing plate 45 secured to the retaining member 21 of the rotor 10 makes sliding contact with the sliding surface 72 of the first bearing member 15. That is to say, the lower surface of the first bearing plate 45 is a rotor side sliding surface 45a in sliding contact with the sliding surface 72 of the first bearing member 15. Grease is applied to the sliding surface 72.

Here, as shown in FIG. 3, the sealing member bottom portion 65 includes a cylindrical bearing support section 75 that surrounds the first bearing member 15 from the outer peripheral side in the radial direction, a coil sealing portion 76 positioned below the coils 53, a connection section 77 that connects between the bearing support section 75 and the coil sealing section 76, and a circular closed section 78 that closes a lower end opening of the cylindrical bearing support section 75. The bearing support section 75 and the closed section 78 constitute the bearing member retaining concave portion 68, and the inner peripheral surface of the bearing support section 75 is the inner peripheral surface of the bearing member retaining concave portion 68. The lower surface of the coil sealing section 76 includes a tapered surface section 76a provided along the shape of the coils 53 wound around the insulators 52, and is downwardly inclined toward the outer peripheral side.

As shown in FIG. 1, the thickness A of the connection section 77 in the axis line L direction is smaller than the thickness B of the bearing support section 75 and the thickness C of the coil sealing section 76. Furthermore, the lower surface of the connection section 77 is positioned further in the upward direction than the lower surface of the bearing support section 75 and the lower surface of the coil sealing section 76. Therefore, as shown in FIG. 3, an annular concave portion 65a, which has the lower surface of the connection section 77 as the bottom surface, is formed on the lower surface of the sealing member bottom portion 65 (resin sealing member 13). Furthermore, the bottom surfaces of the bearing support section 75 and the closed section 78 are positioned further on the downward side than the lower surface of the coil sealing section 76. That is to say, the bearing support section 75 and the closed section 78 that retain the first bearing member 15 protrude further in the downward direction the coil sealing section 76.

Next, as shown in FIG. 4 and FIG. 5, the sealing member cylindrical portion 67 includes, from the downward direction toward the upward direction, a large diameter cylindrical section 81 and a small diameter cylindrical section 82 having a smaller outside diameter dimension than the large diameter cylindrical section 81. As shown in FIG. 1. The outside diameter of the large diameter cylindrical section 81 is larger than the outside diameter of the annular portion 56 of the stator core 51, and the outside diameter of the small diameter cylindrical section 82 is smaller than the outside diameter of the annular portion 56 of the stator core 51.

As shown in FIG. 5, the boundary section between the large diameter cylindrical section 81 and the small diameter cylindrical section 82 in the sealing member cylindrical portion 67 is provided with a plurality of arc-shaped opening portions 83, which upwardly expose the outer peripheral edge section 56a of the annular portion 56 of the stator core 51 from the resin sealing member 13. Furthermore, the outer peripheral side of the arc-shaped opening portions 83 of the resin sealing member 13 is provided with an annular end surface 84 which is orthogonal to the axis line L. The outer peripheral edge section of the stator core 51, which is exposed from the arc-shaped opening portions 83, and the annular end surface 84 are positioned on the same plane orthogonal to the axis line L. The upper end section of the large diameter cylindrical section 81 is provided with four engagement protrusions 85 which protrude on the outer peripheral side at equal angular intervals.

The inner peripheral surface of the sealing member cylindrical portion 67 includes, from the lower side to the upper side, a small diameter inner peripheral surface section 67a and a large diameter inner peripheral surface section 67b having a larger inside diameter dimension than the small diameter inner peripheral surface section 67a. The curvature radius of the small diameter inner peripheral surface section 67a is substantially equal to the curvature radius of the inner peripheral side end surfaces 57a of the salient pole portions 57. The small diameter inner peripheral surface section 67a is provided with a plurality of opening portions 86 which expose the inner peripheral side end surfaces 57a of the salient pole portions 57 of the stator core 51 on the inner peripheral side. Furthermore, the small diameter inner peripheral surface section 67a is provided with notched portions 87 which upwardly expose a section of the axial direction end surfaces 57b of the salient pole portions 57. That is to say, nine notched portions 87 are formed in the small diameter inner peripheral surface section 67a with an angular pitch of 40° around the axis line L. The notched portions 87 are grooves extending in the vertical direction from the edge of the opening portion 86 to the upper end edge of the small diameter inner peripheral surface section 67a. The cross-sectional shape of the notched portions 87 is an arc shape. As a result of providing the plurality of notched portions 87, a circumferential direction central section on the tip sections of the axial direction end surfaces 57b of the salient pole portions 57 become exposed sections 57c which are upwardly exposed.

The inner peripheral side end surfaces 57a of the salient pole portions 57 exposed from the opening portion 86 are continuous with the small diameter inner peripheral surface section 67a without any step. A rust inhibiting agent 88 is applied to the inner peripheral side end surfaces 57a of the salient pole portions 57 exposed from the opening portion 86. Further, the rust inhibiting agent 88 is also applied also to the exposed portions 57c of the axial direction end surfaces 57b of the salient pole portions 57 exposed from the notched portions 87. In the present example, an epoxy coating is used as the rust inhibiting agent 88. Coatings other than epoxy coatings, as well as rust inhibiting oils, and adhesive agents may be used as the rust inhibiting agent 88.

The resin sealing member 13 is formed from a BMC (Bulk Molding Compound). In the present embodiment, the resin sealing member 13 is formed by placing the stator 11 in a mold, and then injecting and curing a resin inside the mold. That is to say, the resin sealing member 13 is integrally molded with the stator 11 by means of insert molding.

Here, in the present embodiment, the inner peripheral side end surfaces 57a of the salient pole portions 57 of the stator core 51 are exposed from the resin sealing member 13. Therefore, during insert molding, a cylinder-shaped mold section is provided in advance in the mold, and the outer peripheral surface of the mold section is brought into contact with the inner peripheral side end surfaces 57a of the salient pole portions 57 to enable positioning the stator core 51 in the radial direction. Furthermore, the resin sealing member 13 upwardly exposes a section (exposed section 57c) of the axial direction end surfaces 57b of the salient pole portions 57 of the stator core 51. In addition, the resin sealing member 13 upwardly exposes the outer peripheral edge section 56a of the annular portion 56 of the stator core 51. Therefore, during insert molding, a first contact portion capable of making contact from the upward direction with the axial direction end surfaces 57b of the salient pole portions 57, and a second contact portion capable of making contact from the upward direction with the outer peripheral edge section of the annular portion 56 are provided in advance in the mold, and the first contact portion and the second contact portion are brought into contact with the stator core 51 to enable positioning of the stator core 51 in the axis line L direction. That is to say, in the present embodiment, the resin sealing member 13 can be formed by injecting a resin into the mold in a state where the stator core 51 placed inside the mold is positioned in the radial direction and in the axis line L direction. Consequently, the accuracy with which the stator core 51 and the resin sealing member 13 are relatively positioned is improved.

The notched portions 87 provided on an inner peripheral surface of the sealing member cylindrical portion 67 are impressions of the first contact portion provided on the mold. That is to say, during insert molding, because the first contact portion provided on the mold is brought into contact with the axial direction end surfaces 57 of the axis line salient pole portions 57b from the axis line L direction, when the BMC solidifies to form the resin sealing member 13, the sections where the first contact portion was making contact consequently become the exposed sections 57c, and the notched portions 87 are provided at the sections where the first contact portion was positioned.

### (Cover Member)

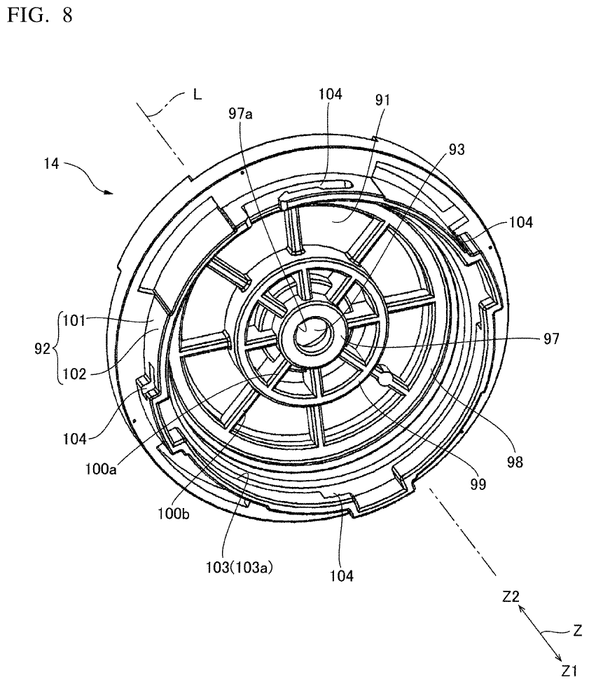

FIG. 8 is a perspective view of the cover member 14 when viewed from the downward direction. The cover member 14 is made of resin, and is secured in the upward direction of the resin sealing member 13.

The cover member 14 includes a disk-shaped cover member ceiling portion 91, and a cover member cylindrical portion 92 which downwardly extends from the cover member ceiling portion 91. The cover member ceiling portion 91 is provided with a through hole 93 at the center which passes through in the vertical direction. As shown in FIG. 1 and FIG. 4, a circular concave portion 94 surrounding the through hole 93 is provided in a central section of the upper surface of the cover member ceiling portion 91. An annular seal member 95 is disposed on the circular concave portion 94.

As shown in FIG. 8, the central section of the lower surface of the cover member ceiling portion 91 is provided with a bearing member retaining cylindrical portion 97 which is coaxially provided with respect to the through hole 93. Furthermore, the lower surface of the cover member ceiling portion 91 is provided with an outer annular rib 98 along the outer peripheral edge of the circular shape. In addition, a circular inner annular rib 99 is provided between the bearing member retaining cylindrical portion 97 and the outer annular rib 98 on the lower surface of the cover member ceiling portion 91. An inner rib 100a which radially extends from the bearing member retaining cylindrical portion 97 and reaches the inner annular rib 99 is provided between the bearing member retaining cylindrical portion 97 and the inner annular rib 99. An outer rib 100b which radially extends from the inner annular rib 99 and reaches the outer annular rib 98 is provided between the inner annular rib 99 and the outer annular rib 98. The bearing member retaining cylindrical portion 97, the outer annular rib 98, and the inner annular rib 99 are coaxially provided. The lower end surface of the bearing member retaining cylindrical portion 97, the lower end surface of the outer annular rib 98, and the lower end surface of the inner annular rib 99 are flat surfaces orthogonal to the axis line L. The amount of protrusion of the bearing member retaining cylindrical portion 97 from the lower surface of the cover member ceiling portion 91 is larger than the amount of protrusion of the inner annular rib 99 from the lower surface of the cover member ceiling portion 91. The amount of protrusion of the inner annular rib 99 from the lower surface of the cover member ceiling portion 91 is larger than the amount of protrusion of the outer annular rib 98 from the lower surface of the cover member ceiling portion 91. The lower surface of the outer rib 100b and the lower surface of the outer annular rib 98 are on the same plane.

As shown in FIG. 8, the bearing member retaining cylindrical portion 97 includes a groove 97a that extends in the vertical direction which is provided in a circumferential direction section of an inner peripheral wall of the central hole. Furthermore, shown in FIG. 1, the second bearing member 16 is retained in the central hole of the bearing member retaining cylindrical portion 97.

Here, the second bearing member 16 is the same member as the first bearing member 15 disposed upside down. The second bearing member 16 is made of resin, and as shown in FIG. 5, includes a cylindrical support portion 70 provided with a through hole in which the rotating shaft 5 passes through, and a flange portion 71 which spreads out on the outer peripheral side from the downward direction end of the support portion 70. A convex portion 70a that has a constant width and extends in the vertical direction is formed on a circumferential direction section of the outer peripheral surface of the support portion 70. The contour of the flange portion 71 is a letter-D shape which includes an arc contour section 71a having an arc shape when viewed from the vertical direction, and a straight contour section 71b which linearly connects both circumferential direction ends of the arc contour section 71a. The straight contour section 71b is positioned on the opposite side of the convex portion 70a with respect to the through hole.

In the second bearing member 16, the support portion 70 is inserted into the bearing member retaining cylindrical portion 97 in a state where the positions of the convex portion 70a of the support portion 70 and the groove 97a of the bearing member retaining cylindrical portion 97 coincide with each other. Further, as shown in FIG. 1, the second bearing member 16 is secured to the bearing member retaining cylindrical portion 97 by inserting the flange portion 71 from the downward direction until it makes contact with the cover member 14 (the cover member ceiling portion 91 and the lower surface of the bearing member retaining cylindrical portion 97). When the second bearing member 16 is secured to the bearing member retaining cylindrical portion 97, the upward direction end surface of the flange portion 71 is orthogonal to the axis line. Here, the support portion 70 functions as a radial bearing of the rotating shaft 5, and the flange portion 71 functions as a thrust bearing of the rotor 10. The upper surface of the flange portion 71 becomes a sliding surface 72 in sliding contact with the rotor 10. That is to say, the downward direction surface of the second bearing plate 46 secured to the retaining member 21 of the rotor 10 makes sliding contact with the sliding surface 72 of the second bearing member 16. That is to say, the upper surface of the second bearing plate 46 is a rotor side sliding surface 46a in sliding contact with the sliding surface 72 of the second bearing member 16. Grease is applied to the sliding surface 72.

As shown in FIG. 1, the cover member cylindrical portion 92 downwardly extends from the outer peripheral side of the outer annular rib 98. The cover member cylindrical portion 92 includes an upper annular cylindrical section 101 that overlaps and covers from the outside peripheral side the small diameter cylindrical section 82 of the resin sealing member 13, and a lower annular cylindrical section 102 positioned below the upper annular cylindrical section 101 and on the outer peripheral side of the large diameter cylindrical section 81. As shown in FIG. 8, an annular stepped portion 103 is provided on the inner peripheral surface of the cover member cylindrical portion 92 between the upper annular cylindrical section 101 and the lower annular cylindrical section 102. The annular stepped portion 103 includes an annular surface 103a facing in the downward direction. The annular surface 103a is a flat surface orthogonal to the axis line L. The lower annular cylindrical section 102 is provided with locked portions 104 that engage the engagement protrusions 85 of the resin sealing member 13 in four locations in the circumferential direction.

Here, the cover member 14 is covered by the resin sealing member 13 from the upward direction in a state where the rotor 10 is disposed on the inside of the resin sealing member 13, and rotor 10 is supported by the first bearing member 15. When the resin sealing member 13 is covered by the cover member 14, an adhesive agent is applied to an outer peripheral edge section on the upper surface of the resin sealing member 13.

When the resin sealing member 13 is covered by the cover member 14, as shown in FIG. 1, a lower end section of the inner annular rib 99 is fitted to the inner peripheral side of the sealing member cylindrical portion 67 of resin sealing member 13. Consequently, the cover member 14 and the resin sealing member 13 are positioned in the radial direction, and the axis line L of the rotating shaft 5 coincides with the central axis line of the stator 11. Further, the annular surface 103a of the annular stepped portion 103 of the cover member cylindrical portion 92 is brought into contact with the annular end surface 84 between the large diameter cylindrical section 81 and the small diameter cylindrical section 82 of the resin sealing member 13. As a result, the cover member 14 and the resin sealing member 13 are positioned in the axis line L direction. Thereafter, the cover member 14 and the resin sealing member 13 are relatively rotated in the circumferential direction, and as shown in FIG. 3, the engagement protrusions 85 of the resin sealing member 13 and the locked portions 104 of the cover member 14 are engaged. Consequently, the cover member ceiling portion 91 covers the rotor 10 and the resin sealing member 13 from the upward direction in a state where the rotating shaft 5 is passing through in the vertical direction. Furthermore, the seal member 95 disposed in the circular concave portion 94 of the cover member ceiling portion 91 seals between the rotating shaft 5, the cover member 14, and the second bearing member 16. In addition, the upper annular cylindrical section 101 of the cover member cylindrical portion 92 surrounds the small diameter cylindrical section 82 of the resin sealing member 13 from the outer peripheral side.

Here, the case body 3 is placed on the cover member 14 from the upward direction. As a result, the space partitioned between the cover member 14 and the case body 3 becomes the pump chamber 4. The inlet port 7 is provided in a position overlapping the axis line L of the rotating shaft 5 of the motor 2 in the case body 3. The discharge port 8 is provided outside the rotating shaft 5 in the radial direction. When the motor 2 is driven to rotate the impeller 6, fluid is drawn from the inlet port 7 and discharged from the discharge port 8.

### (Operational Effects)

In the present example, in the resin sealing member 61 and the sealing member bottom portion 65, a connection section 77 is provided between the bearing support section 75, which surrounds the first bearing member 15 from the outer peripheral side, and the coil sealing section 76, which is positioned below the coils 53, the thickness of the connection section 77 in the axis line L direction being smaller than that of these sections. Therefore, when heat generated by energizing a coil 53 is conducted from the coil sealing section 76 to the inner peripheral side, the conduction is inhibited at the connection section 77, making conduction to the bearing support section 75 less likely. As a result, is possible to prevent or inhibit deformation of the bearing support section 75 caused by the heat and the resulting change in the posture of the first bearing member 15, and therefore, the rotational accuracy of the rotor 10 can be maintained. Therefore, in the pump device 1, the rotational accuracy of the impeller 6 attached to the rotating shaft 5 of the rotor 10 can be maintained.

Furthermore, in the present example, the lower surface of the connection section 77 is positioned in the upward direction of the lower surface of the bearing support section 75 and the lower surface of the coil sealing section 76, and the annular concave portion 65a, which has the lower surface of the connection section 77 as the bottom surface (ceiling surface), is formed on the lower surface of the sealing member bottom portion 65. As a result, because the surface area of the lower surface of the sealing member bottom portion 65 (lower surface of the resin sealing member 61) increases, heat from the coils 53 can be released via the sealing member bottom portion 65.

In addition, in the present example, because the lower surface of the bearing support section 75 is positioned in the downward direction of the lower surface of the coil sealing section 76, the surface area of the lower surface of the resin sealing member 61 can be increased compared to a case where the lower surface of the bearing support section 75 and lower surface of the coil sealing section 76 are positioned with the same height. Therefore, heat from the coils 53 can be released via the sealing member bottom portion 65.

Moreover, in the present example, the coil sealing section 76 includes the tapered surface section 76a provided along the shape of the coils 53 which is downwardly inclined toward the outer peripheral side. If such a tapered surface section 76a is provided, the surface area of a section of the coil sealing section 76 facing the coils 53 in the axis line L direction increases. Therefore, heat from the coils 53 is released via the tapered surface section 76a.

Further, in the present example, the groove 68a, which extends in the vertical direction, is provided in the inner peripheral surface of the bearing member retaining concave portion 68 (inner peripheral surface of the bearing support section 75) provided on the sealing member bottom portion 65, the convex portion 70a, which extends in the vertical direction, is provided on the support portion 70 of the first bearing member 15 inserted into the bearing member retaining concave portion 68, and the convex portion 70a is fitted to the groove 68a at the time the first bearing member 15 is retained by the bearing member retaining concave portion 68. As a result, the first bearing member 15 retained by the bearing member retaining concave portion 68 can be prevented from rotating around the axis line L. Similarly, the groove 97a, which extends in the vertical direction, is provided in the inner peripheral surface of the bearing member retaining cylindrical portion 97 of the cover member 14, the convex portion 70a, which extends in the vertical direction, is provided on the support portion 70 of the second bearing member 16 inserted into the bearing member retaining cylindrical portion 97, and the convex portion 70a is fitted to the groove 97a at the time the second bearing member 16 is retained by the bearing member retaining cylindrical portion 97. As a result, the second bearing member 16 retained by the bearing member retaining cylindrical portion 97 can be prevented from rotating around the axis line L.

In addition, the contour of the flange portions 71 of the first bearing member 15 and the second bearing member 16 is a letter-D shape which includes the arc contour section 71a and the straight contour section 71b, and the straight contour section 71b is positioned on the opposite side of the convex portion 70a with respect to the central hole of the cylindrical portion 71. Therefore, the position of the convex portion 70a formed on the cylindrical portion 70 can be grasped even when the bearing members 15 and 16 are viewed from the flange portion 71 side. As a result, the convex portions 70a of the bearing members 15 and 16 are easily fitted with respect to the groove 68a of the bearing member retaining concave portion 68 and the groove 97a of the bearing member retaining cylindrical portion 97.

### Other Embodiments

Groove portions may be formed in the bearing members 15 and 16, and convex portions may be formed near the bearing member retaining concave portion 68 and the bearing member retaining cylindrical portion 97, which retain the bearing members 15 and 16.

Furthermore, a marker protrusion portion for disposing the straight contour section 71b of the flange portion 71 of the first bearing member 15 inserted into the bearing member retaining concave portion 68 at a predetermined angular position around the axis line L may be provided in a position near the bearing member retaining concave portion 68 on the upper surface of the sealing member bottom portion 65 on the inner peripheral side of the sealing member cylindrical portion 67. For example, a bow-shaped marker 110 such as the dotted line shown in FIG. 5 may also be provided. In this manner, when the first bearing member 15 is retained by the bearing member retaining concave portion 68, the convex portion 70a can be easily fitted to the groove 68a.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A motor comprising:
a rotor comprising a rotating shaft and a magnet;
a bearing member that rotatably supports the rotating shaft;
a stator comprising a plurality of coils annularly arranged on an outer peripheral side of the rotor; and
a resin sealing member covering the coils; wherein,
the resin sealing member comprises a bottom portion that covers the bearing member and the plurality of coils from a first direction side along an axis of the rotating shaft, a second direction side along the axis being opposite to the first direction side,
the bottom portion comprises a cylindrical bearing support section which surrounds the bearing member from an outer peripheral side in a radial direction, a coil sealing section positioned on the first direction side of the coils, and a connection section that connects between the bearing support section and the coil sealing section, and
a thickness of the connection section in an axial direction is smaller than a thickness of the bearing support section and the coil sealing section.

2. The motor according to claim 1, wherein
a first direction side end surface of the connection section is positioned further to the second direction side of the axis than a first direction side end surface of the bearing support section and a first direction side end surface of the coil sealing section.

3. The motor according to claim 1, wherein
a first direction side end surface of the bearing support section is positioned further to the first direction of the axis than a first direction side end surface of the coil sealing section.

4. The motor according to claim 1, wherein
the stator comprises an annular portion and a plurality of salient pole portions that protrude inward in a radial direction from the annular portion,
the plurality of coils is wound around each of the plurality of salient pole portions via an insulator,
the coils wound around the insulator protrude in the first direction toward an outer peripheral side in a radial direction, and
a first direction side end surface of the coil sealing section comprises a tapered surface section provided along the shape of the coils which is inclined in the first direction toward the outer peripheral side.

5. The motor according to claim 1, wherein
the bearing member comprises a cylindrical portion in which the rotating shaft passes through, and a flange portion which spreads out on an outer peripheral side from a second direction end of the cylindrical portion,
the cylindrical portion is retained by the bearing support section from an outer peripheral side,
the flange portion makes contact with the bearing support section from the second side, and
a convex portion is formed on either an outer peripheral surface of the cylindrical portion or an inner peripheral surface of the bearing support section, and a concave portion which is fitted to the convex portion is formed on an other surface of the outer peripheral surface of the cylindrical portion and the inner peripheral surface of the bearing support section.

6. The motor according to claim 5, wherein
a contour of the flange portion is a letter-D shape which includes an arc contour section, and a straight contour section which linearly connects both circumferential direction ends of the arc contour section, and
the straight contour section is positioned on the opposite side of the convex portion with respect to a central hole of the cylindrical portion.

7. The motor according to claim 6, wherein
a marker protrusion for disposing the straight contour section of the flange portion of the bearing member retained by the bearing support section at a predetermined angular position about the axis is provided on the second direction end surface of the bottom portion.

8. A pump device comprising:
a motor comprising:
a rotor comprising a rotating shaft and a magnet;
a bearing member that rotatably supports the rotating shaft;
a stator comprising a plurality of coils annularly arranged on an outer peripheral side of the rotor; and
a resin sealing member covering the coils; wherein,
the resin sealing member comprises a bottom portion that covers the bearing member and the plurality of coils from a first direction side along an axis of the rotating shaft, a second direction side along the axis being opposite to the first direction side,
the bottom portion comprises a cylindrical bearing support section which surrounds the bearing member from an outer peripheral side in a radial direction, a coil sealing section positioned on the first direction side of the coils, and a connection section that connects between the bearing support section and the coil sealing section, and
a thickness of the connection section in an axial direction is smaller than a thickness of the bearing support section and the coil sealing section; and
an impeller attached to the rotating shaft.

9. The motor according to claim 4, wherein
a first direction side end surface of the bearing support section is positioned further to the first direction side than the first direction side end surface of the coil sealing section.

10. The motor according to claim 9, wherein
a first direction side end surface of the connection section is positioned further to the second direction side than the first direction side end surface of the bearing support section and the first direction side end surface of the coil sealing section.
